(19) United States
(12) Patent Application Publication
(10) Pub. No.: US 2011/0154705 A1
(43) Pub. Date: Jun. 30, 2011

(54) MULTI-CARD DISPLAY HOLDER FOR WINDSHIELDS AND RELATED METHOD

(75) Inventor: John David Gardiner, Miami Beach, FL (US)

(73) Assignee: PARK 'N DISPLAY, LLC, Miami Beach, FL (US)

(21) Appl. No.: 12/709,808

(22) Filed: Feb. 22, 2010

Related U.S. Application Data
(60) Provisional application No. 61/290,865, filed on Dec. 29, 2009.

(51) Int. Cl. G09F 21/04

(52) U.S. Cl. 40/643

(57) ABSTRACT

The invention is directed toward a card display holder for displaying and storing one or more placards on the interior side of a vehicle windshield. The card display holder includes a left side wall and a corresponding right side wall where the left side wall is essentially parallel to the right side wall. Positioned between both side walls is a back wall. Also, the card display holder has a front wall that includes a left portion and a corresponding right portion, the left portion being essentially parallel to the right portion. A bottom wall connects the front wall to the back wall creating a surface area sufficient for one or more placards to rest within the card display holder. A aperture can be positioned within the back wall. The card display holder is preferably of unibody in construction and manufactured from a plastic or composite.

### CROSS-REFERENCE TO RELATED APPLICATIONS

This application claims priority to U.S. Provisional Patent Application No. 61/290,865 filed on Dec. 29, 2009, the contents of which are herein incorporated by reference.

### FIELD OF THE INVENTION

This invention is directed to a card display holder attached to the interior of a vehicle windshield that allows placement, display and storage of a variety of different shaped and sized placards (including but certainly not limited to authorization slips, tickets, receipts, coupons, permits, and access cards). More specifically, the invention allows a driver to place a plurality of placards into the holder for display and storage to reduce clutter on the vehicle dashboard.

### BACKGROUND OF THE INVENTION

Vehicle drivers, especially those in urban areas, typically acquire and maintain a plurality of various authorization slips in order to park, drive and gain entry into a variety of parking areas (both on-street public lots as well as private lots) and garages, events, sporting arenas and other facilities. One example of such an authorization slip is the ticket commonly purchased from ticket machines used for regulating parking in urban areas and car parks. More specifically, recent advances have led to automated so-called “pay and display” ticket machines along urban areas and car parks which allow drivers to purchase spans of time to park within a certain locale. Upon credit card, debit card or cash payment, these machines produce a ticket that generally identifies the location and operator of the machine, expiration time, fee paid and time entered, with such ticket to be displayed proximate to, and in a manner clearly visible through, the driver's windshield.

These placards are required to be clearly displayed such that an enforcement officer is able to verify if a vehicle is authorized to access or to park in a designated area. Over time, these tickets invariably accumulate on vehicle dashboards, which could make it difficult for parking enforcement to verify. This may not only cause clutter and confusion, but may also risk compromising the vehicle's ventilation system—as these tickets/receipts could become lodged in the air vents. In addition, depending on the design of the vehicle, these tickets may become lodged in the tight corner where the dashboard and windshield intersect, becoming difficult for the driver to retrieve. Also, some vehicles have dark window tinting along the bottom of the windshield which may have the effect of obstructing the display of the ticket/receipt through the windshield when placed on the dashboard. Whether due to accumulation or obstruction, or simply in the event that the placard falls off the dashboard, if parking enforcement authorities are prevented from verifying the ticket, the driver could receive a parking fine or penalty.

A second example of an authorization slip is a ticket or receipt to allow access to a facility such as a parking garage, a nature preserve, or a musical, sporting, religious, or other cultural or business event. Drivers typically must receive and post these parking slips upon entering the facilities. Often, these facilities require the continued display of the authorization slip through the windshield while the vehicle is parked in the facility. It is desirable to allow a clear and unobstructed display of such slip. Routine use of such facilities (and/or automated “pay and display” ticket machines described above) again can often result in disorganization of these slips causing clutter and difficulty for relevant authorities to verify authorized access.

As a third exemplar of an authorization slip, drivers often must use an electro-magnetic or RF-tagged card when parking at the workplace. This tagged card denotes entry into the parking facility as well as exit from that facility. A computer often determines the times and frequency of use of the parking facility at the workplace. For example, unless the driver uses the card for entry into the parking facility, the card cannot be used to exit that facility. Thus, it is important to properly house and store these tagged cards when not in use for easy and ready access to the tagged cards.

A fourth example of an authorization slip is a coupon or pass for utilizing a toll road or turnpike, where the driver needs to access and present the coupon or pass at various stops while utilizing the road. It is useful to have a holder for these cards when not in use for easy and ready access to the cards.

Accordingly, there is a need for a simple yet effective solution that allows effective and direct display of vehicle authorization slips (i.e., placards) such as parking tickets, receipts, coupons, permits, and access cards for view by municipal authorities, parking attendants and other enforcement personnel. Moreover, there is a need for an apparatus to help organize and store a plurality of these placards. Finally, such system should also allow for easy transfer or removal of the placards by the driver in and out of the system to properly shuffle and arrange the placards during different times of day to correspond to different authorization needs or to remove the placards for accounting purposes or for disposal.

### SUMMARY OF THE INVENTION

The present invention solves many of the aforementioned needs for a placard display and holder to help better organize and maintain various placards which can include various authorization slips, parking tickets, receipts, coupons and the like. The card display holder, preferably located in the interior side of the windshield of the vehicle first includes a left side wall and a corresponding right side wall where the left side wall is essentially parallel to the right side wall. Positioned between both side walls is a back wall.

In addition, the card display holder can include front wall that has a left portion and a corresponding right portion, the left portion being essentially parallel to the right portion. A bottom wall connects the front wall to the back wall, as well as creating a surface area sufficient to maintain and house one or more placards. The left and right portions of the front wall connect to the bottom wall which creates an opening that is adequate for the placard to be viewed directly through the windshield (i.e., the card display holder is mostly open in the front displaying the placard directly through the windshield). The back wall may include an opening that facilitates arrangement, relocation and removal of one or more placards.

The card display holder may be of unibody construction and manufactured from a plastic or composite which may be solid, translucent or transparent. The card display holder can attach to the windshield through one or more fasteners which can include (but is no way limited to) an adhesive such as glue or a hook-and-loop fastener. The card display holder may also attach in certain vehicles through wedging it in the corner created where the windshield and the dashboard intersect.

The invention further contemplates a method for using the card display holder. This method may include affixing the card display holder to the interior side of the windshield. This can include use of a fastener such as an adhesive or hook-and-loop fastener. Secondly, one or more placards may be positioned within the card display holder, where at least one placard is capable of being viewed from (and through) the exterior side of the windshield. When affixed to the windshield, the most-current placard may be placed and displayed first through the windshield, unless otherwise purposely arranged. As yet a third step, these placards may be arranged through use of an aperture or simply removed for accounting purposes or for disposal. These three steps may be repeated to display and organize the various placards as needed dependent upon the authorization needs of the driver.

### BRIEF DESCRIPTION OF THE DRAWINGS

For a fuller understanding of the invention, reference is made to the following detailed description, taken in connection with the accompanying drawings illustrating various embodiments of the present invention, in which:

FIG. 1 provides a perspective view of the card display holder;

FIG. 2 provides a front view of the card display holder;

FIG. 3 provides a top view of the card display holder;

FIG. 4 provides a side view of the card display holder;

FIG. 5 provides a perspective view of the card display holder attached to the interior of a vehicle windshield;

FIG. 6 provides a perspective view from the inside of a vehicle windshield showing the back wall of the card display holder; and

FIG. 7 provides a perspective view of an alternative embodiment for the card display holder having an aperture which opens toward the top of the back wall.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### The Apparatus

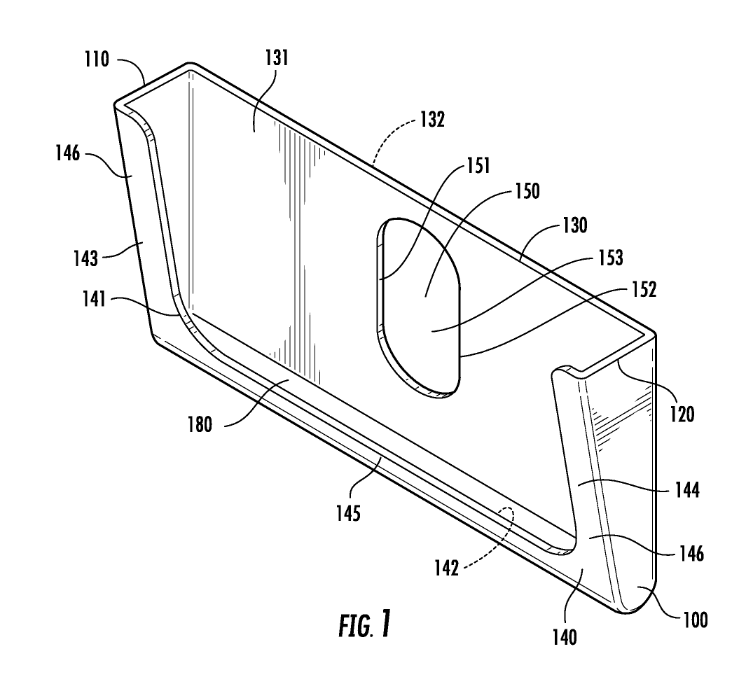

FIG. 1 illustrates, by way of example, one embodiment of the card display holder 100. As shown, the card display holder 100 includes a left side wall 110 and a right side wall 120. The left side wall 110 is essentially in parallel relationship with the right side wall 120. Positioned between both side walls 110 and 120 is a back wall 130. The back wall 130 includes a first side 131 and a corresponding second side 132.

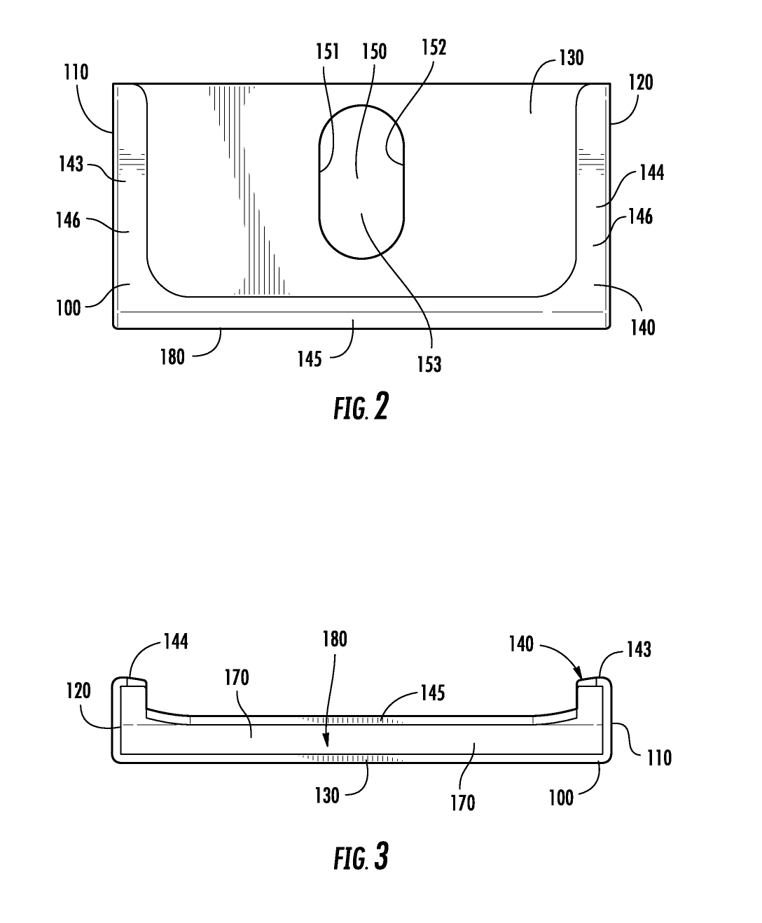

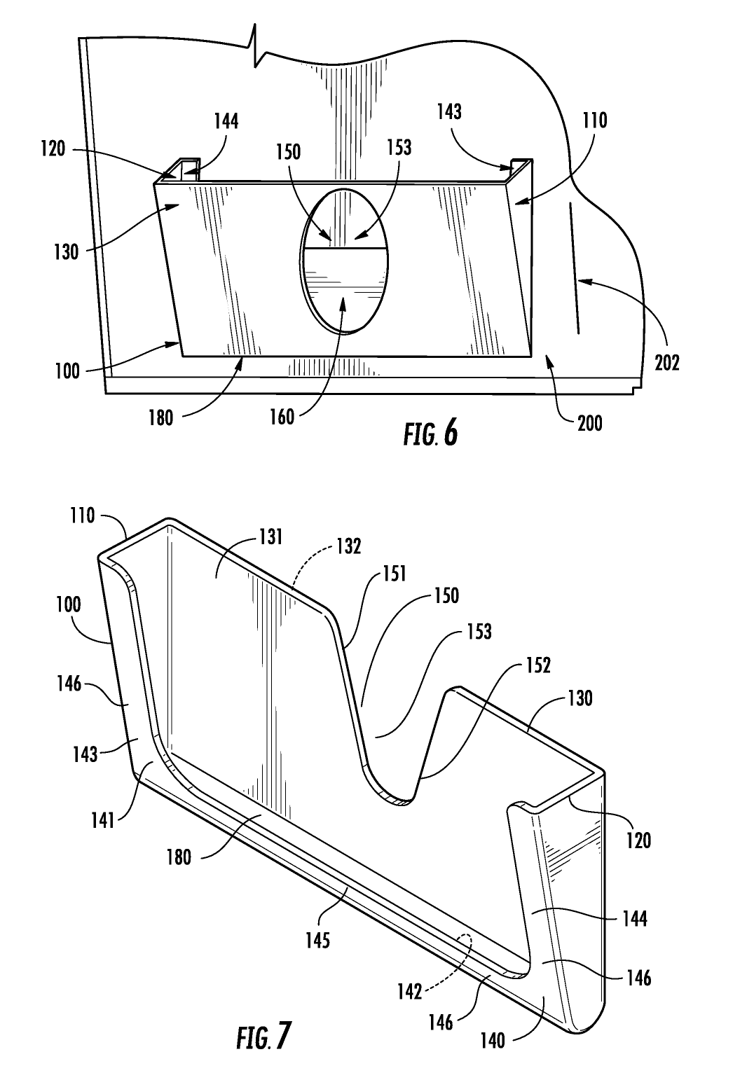

As shown in FIG. 2, the card display holder 100 also includes a front wall 140 positioned between both the left side wall 110 and right side wall 120. This front wall 140 includes a first side 141 and a corresponding second side 142 (both shown and illustrated in FIG. 1). Located on the first side 141 of the front wall 140 are three portions 143-145. These include a left portion 143, a corresponding right portion 144, and a bottom portion 145. The left portion 143 is preferably parallel to the right portion 144. The bottom portion 145 is perpendicular to both the left portion 143 and right portion 144. All three portions 143-145 create a sufficient surface area to affix the card display holder 100 onto a windshield 200 (shown in FIGS. 5 and 6 described below) through use of an adhesive 146. The adhesive 146 can be any type of fastener known to those of ordinary skill in the art including, but certainly not limited to glue, epoxy or a hook-and-loop fastener. However, the card display holder 100 can also be designed to fit within the space between the windshield 200 (shown in FIG. 5) and dashboard (near the corner where they intersect) such that it does not require use of adhesive 146.

As further illustrated by FIG. 2, the card display holder 100 can include an aperture 150 located within the back wall 130. This aperture 150 creates an opening 153 (which can be elliptical, circular or even “U” shaped to include the opening 153 at the top of the back wall 130) at both the first side 151 and corresponding second side 152 of the back wall 130. While the aperture 150 shown in FIG. 2 is preferably elliptical, such aperture 150 can be of any size or orientation including a “U” shape as shown in FIG. 7 described below. Moreover, this aperture 150 has a sufficient size and dimension to allow the driver to place one or more fingers within the opening 153 to help remove, position, arrange and relocate each placard 160 (shown in FIGS. 5 and 6) within the card display holder 100.

FIG. 3 offers a top view of the card display holder 100. As shown in FIG. 3, the position and orientation of the back wall 130 and the front wall 140 create a void 170 of sufficient thickness to create a pocket which can house, maintain and store a variety of different shaped and sized placards 160.

The card display holder 100 illustrated in FIG. 1 through FIG. 3 is preferably translucent or transparent—such that the driver can denote the existence of one or more placards 160. However, the card display holder 100 can also be a solid color. In addition, the card display holder 100 illustrated in FIG. 1 through FIG. 3 is preferably of unibody construction created through injection molding to add strength and stability to the apparatus. Through the aperture 150 the driver can denote the existence of one or more placards 160. Moreover, the card display holder 100 is preferably manufactured out of a light weight and resilient polymer or composite capable of being injection molded.

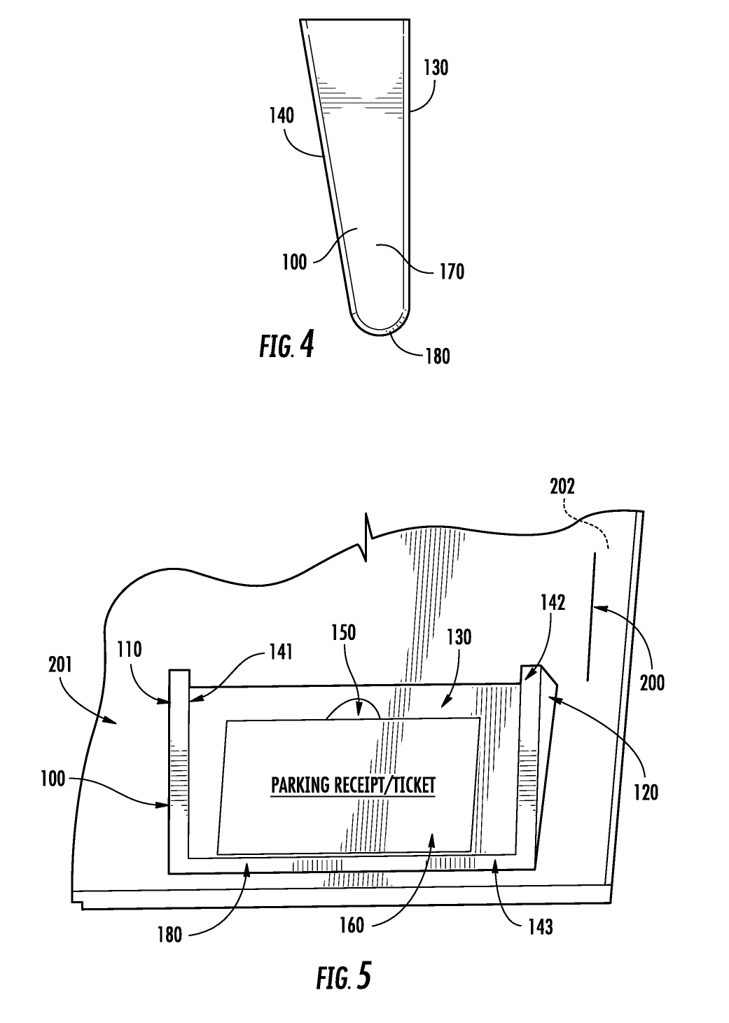

As shown in FIG. 4, the back wall 130 and the front wall 140 can preferably connect through a bottom wall 180. Put another way, the void 170 illustrated in FIG. 3 can be properly sized and configured through a bottom wall 180 positioned between the front wall 140 and back wall 130. It is on this bottom wall 180 that each placard 160 rests while positioned within the pocket formed by the walls 130, 110, 120, 140, 180 and windshield 200 of the card display holder 100.

FIG. 4 illustrates how the bottom wall 180 is preferably upwardly curved in shape and orientation in one embodiment. This curved shape and the angle of the right side wall 120 (which is generally identical to the angle of the left side wall 110 identified in other Figures) creates the pocket that allows the driver to more easily position as well as remove stored placards 160 through use of the aperture 150 on the back wall 130 of the card display holder 100.

### Placement of Apparatus in Vehicle

FIG. 5 illustrates how the card display holder 100 can be viewed through the exterior side 201 of the vehicle windshield 200. Such windshield 200 has an exterior side 201 and a corresponding interior side 202. As shown, the card display holder 100 is capable of fitting within the gap between the windshield 200 and the dashboard of the vehicle. In this embodiment, an adhesive 146 helps affix the front wall 140 onto the interior side 202 of the windshield 200. Each portion 143-145 can optionally include adhesive 146 sufficient to maintain the card display holder 110 onto the interior side 202 of the windshield 200, thereby displaying the placard 160 directly through the exterior side 201 of the windshield 200. The left and right portions 143 and 144 of the front wall connecting to the bottom portion 145 creates an opening 153 that is adequate for the placard 160 to be viewed directly through the exterior side 201 of the windshield 200 (i.e., the card display holder 100 is mostly open in the front displaying the placard 160 through the exterior side 201 of the windshield 200).

Further shown in FIG. 5 is a placard 160 positioned within the card display holder 100 capable of being viewed from the exterior side 201 of the windshield 200. As previously discussed, the placard 160 can be any type of authorization slip, including but certainly not limited to parking tickets, parking passes, coupons, permits, vouchers, handicap signs, electromagnetic access cards, and other receipts. The gap between the first side wall 110 and second side wall 120 is of a sufficient size and dimension in order to maintain and house various sized placards 160. This includes ensuring that the back wall 130 is of a sufficient length to fit the corresponding lengths of the largest of such placards 160.

FIG. 6 shows how the card display holder 100 attaches to the interior side 202 of the vehicle windshield 200. As shown, the back wall 130 includes an aperture 150 that includes an opening 153. Such aperture 150 can be any shape and size sufficient to allow the finger of a driver to help manipulate, remove and arrange the various placards 160.

FIG. 7 offers an alternative embodiment to the card display holder 100. This embodiment includes the aperture 150 having an opening 153 that distally ends at the top of the back wall 130. This opening 153 is essentially “U” shaped in size and orientation and extends throughout the back side 140 of the card display holder 100. Moreover, this aperture 150 has a sufficient size and dimension to allow the driver to place one or more fingers within the opening 153 to help remove, position, arrange and relocate each placard 160 (shown in FIGS. 5 and 6) within the card display holder 100.

### Method of Use

In addition to the apparatus described above, the invention is also directed toward a method of use. The method first includes the step of affixing the card display holder to an interior side 202 of the windshield 200 shown in FIG. 5. This can be accomplished through use of an adhesive 146, which can be any fastener known to those of ordinary skill in the art. The preference is to use a hook-and-loop fastener so that the driver can remove the card display holder 100 if it in any way obstructs vision through the windshield or if its use while moving violates any applicable laws. As previously discussed, the card display holder 100 includes a left side wall 110, a right side wall 120, a back wall 130, a front wall 140 as well as a bottom wall 180.

The second step is positioning one or more placards 160 within the card display holder 100. As is further shown in FIG. 5, this preferably includes ensuring that the proper information contained on the placard 160 is directly displayed through the exterior side 201 of the windshield 200. As a third step, a plurality of placards 160 may be accumulated and stored in the card display holder 100. The various placards 160 may be arranged to allow proper display of a desired placard 160 through removing, organizing and relocating that desired placard 160 through use of the aperture 150. Alternatively, the driver can remove the placards 160 for accounting purposes or for disposal.

These three steps can be repeated dependent upon the desired placard 160 to be displayed. For example, in the morning a parking pass may need to be shown through the windshield 200. Later, a handicapped authorization may be shown when transporting an elderly family member. Still later, a driver may acquire a pay and display ticket that needs to be displayed after parking along an urban street. As shown by the foregoing, each of these various placards 160 can be arranged, stored and maintained within the card display holder 100 in an organized fashion—thereby reducing clutter.

I claim:

1. A card display holder located proximate to the interior side of a vehicle windshield, the card holder comprising:
a left side wall and a corresponding right side wall where the left side wall is essentially parallel to the right side wall;
a back wall positioned between the left side wall and the right side wall;
a front wall which includes a left portion and a corresponding right portion, the left portion being essentially parallel to the right portion; and
a bottom wall which connects the front wall to the back wall which creates a pocket sufficient for one or more placards to rest within the card display holder.

2. The card display holder of claim 1, wherein:
the card display holder is manufactured from a plastic that is translucent.

3. The card display holder of claim 1, wherein:
the card display holder is of unibody construction.

4. The card display holder of claim 1, further comprising a windshield wherein:
the card display holder is affixed to the an interior side of the windshield through one or more fasteners.

5. The card display holder of claim 1, wherein:
the back wall includes a aperture.

6. The card display holder of claim 1, wherein:
the bottom wall includes an upwardly curved shape.

7. A method of storing and displaying one or more placards proximate to an interior of a vehicle windshield, the method comprising the steps of:
(a) affixing a card display holder on the interior side of the windshield, where the card display holder includes
a left side wall and a corresponding right side wall where the left side wall is essentially parallel to the right side wall,
a back wall positioned between the left side wall and the right side wall,
a front wall that has a left portion and a corresponding right portion, the left portion being essentially parallel to the right portion,
a bottom wall which connects the front wall to the back wall which creates a pocket sufficient for one or more placards to rest within the card display holder, and
an aperture positioned within the back wall;
(b) positioning one or more placards into the card display holder; and
(c) arranging the placards within the card display holder through removing and relocating at least one placard through use of the aperture.

8. The method of claim 7, including the additional step of:
repeating steps (a) through (c) as needed to display certain placards as needed.

9. The method of claim 7, wherein:
the card display holder is manufactured from a plastic that is translucent.

10. The method of claim 7, wherein:
the card display holder is of unibody construction.

11. The method of claim 7, wherein:
the card display holder is affixed to the an interior side of the windshield through one or more fasteners.

12. The method of claim 7, wherein:
the back wall includes an aperture, and wherein the one or more placards is arrange by access through the aperture.

13. The method of claim 7, wherein:
the bottom wall includes an upwardly curved shape.

14. The method of claim 12, wherein:
the aperture has an essentially a “U”-shape that distally ends at the top of the back wall.
